(19) United States
(12) Patent Application Publication
(10) Pub. No.: US 2026/0110621 A1
(43) Pub. Date: Apr. 23, 2026

(54) A SENSOR CONNECTING BRIDGE, A SENSOR COUPON, A CORROSION MEASURING DEVICE FOR MONITORING OF AIRBORNE CORROSIVITY, A BRIDGE HOLDER, A MONITORING SYSTEM AND A METHOD OF MONITORING OF AIRBORNE CORROSIVITY

(71) Applicant: Camfil Aktiebolag, Stockholm (SE)

(72) Inventors: Thi Quynh NGUYEN, Versailles (FR); Kenny HEDLUND, Trosa (SE); Andreas THOMANN, Wallenwil (CH); Ivo SENN, Wil (CH); Guillaume GALLET, Bromma (SE); Mikael FORSLUND, Bromma (SE); Lukas GASSER, Wäld (CH); Reto VENTRUTO, Triesenberg (LI); Roman MEULI, Vilters (CH); André RÖMER, Zürich (CH)

(21) Appl. No.: 19/111,381

(22) PCT Filed: Sep. 26, 2023
(86) PCT No.: PCT/SE2023/050942

§ 371 Date: Mar. 13, 2025

(30) Foreign Application Priority Data
Sep. 26, 2022 (SE) 2251114-1

(51) Int. Cl. G01N 17/04; G01D 5/16; G01D 18/00; G01N 17/00; H01R 13/66; H01R 31/00

(52) U.S. Cl. CPC G01N 17/046; G01D 5/16; G01D 18/00; G01N 17/006; H01R 13/6616; H01R 13/6683; H01R 31/005; G01D 2218/10

(57) ABSTRACT

A sensor connecting bridge (1) configured to be used in connection with a corrosion measuring device (20) for monitoring of airborne corrosivity, said sensor connecting bridge comprising at least one connector assembly (3a,3b;4a,4b) configured to enable electrical connection between said measuring device (20) and at least one sensor coupon (30a,30b) inserted into the sensor connecting bridge, and a computer readable memory comprising information about the sensor bridge identity. A sensor coupon (30) adapted to be used in connection with the sensor bridge (1), a sensor connecting bridge arrangement, a corrosion measuring device (20) for monitoring of airborne corrosivity, a passive sensor connecting bridge holder (41) for offline corrosivity determination, a monitoring system (21) for monitoring of airborne corrosivity in one or more different locations and a method of monitoring of airborne corrosivity in one or more different locations using the monitoring system (21).

### TECHNICAL FIELD

The present disclosure relates to monitoring of airborne corrosivity and equipment therefore. More specifically, the disclosure relates to a sensor connecting bridge configured to be used in connection with a corrosion measuring device for monitoring of airborne corrosivity, a sensor coupon adapted to be used in connection with the sensor bridge, a corrosion measuring device for monitoring of airborne corrosivity, a passive sensor connecting bridge holder, a monitoring system for monitoring of airborne corrosivity in one or more different locations and a method of monitoring of airborne corrosivity in one or more different locations using the monitoring system as defined in the introductory parts of the independent claims.

### BACKGROUND

Corrosivity is the term describing an environment's ability to cause corrosion on metal surfaces. All corrosion research that aim to expose samples or measurement devices in a field environment tries to assess the corrosivity or the corrosion damage on a specific object.

Important applications where corrosivity measurements are of great importance include communication/data transfer facilities, industrial process control installations, sensitive production and cultural heritage premises. A challenge is that the atmospheric corrosivity of an environment depends on a complex interaction between the contaminants present in everyday environments as well as temperature and relative humidity.

The corrosivity in a location is not straightforward to measure, as it cannot be assumed that the level of corrosivity will be equal even within a small area. The corrosivity will vary with the moisture level on surfaces which in turn are dependent on the relative humidity, which is in turn dependent on temperature. In an outdoor environment the temperature and humidity variation may be large and condensation will occur in a daily cycle. Similar problems may arise also in indoor locations, where there may be a variation at different heights, especially if the room is includes equipment that dissipates heat and has fans to circulate air.

Besides temperature and humidity, a contaminant is required to cause corrosion. This may simply be the oxygen of the air or one of the many of common contaminants present in urban and industrial sites e.g. sulphur dioxide, nitrogen oxides, or hydrogen sulfide. Fine particles in the atmosphere that may deposit on surfaces may contain corrosive contaminants, e.g. in the form of salts. All these contaminants present outdoor may enter indoor locations, and indoor sources like organic acids and aldehydes may add to the outdoor sources.

In both outdoor environment and indoor environment, e.g. a room with conditioned air, where it is desired to assess the corrosivity, it is important to be able to select the appropriate measuring location to obtain the desired information. It is also important to select a suitable method to assess the corrosivity. Many techniques have been suggested in research and practical work, all having their own merits and drawbacks. A number of standards for corrosivity and environmental parameters are also available, such as ISO 11844, ISO 9223, ISO 9226 and ISO 9225, ANSI/ISA-71.04-2013 and ASTM B825-02 (2008).

ANSI/ISA-71.04-2013 is widely used in many environments and was originally developed to determine the corrosion of metal connectors in telephone switchboards. It is today used in all environments from museums and other cultural heritage facilities to server halls.

This standard uses solid metal coupons of copper and silver as sensor surfaces that is exposed in an environment for nominally 30 days whereafter the thickness of corrosion products is determined ex-situ by a laboratory procedure. The thickness values are then converted to a classification scale with levels G1, G2, G3 and GX where G1 is the least severe and GX the most severe. Even if there is a method to recalculate an exposure shorter or longer than 30 days the method are time consuming, and the severity level is only available after the ex-situ laboratory procedure.

These drawbacks have resulted in the development of several different equipment that tries to determine a value in situ, without removing the sensor surface and allowing the measurement to continue, that can be correlated to the G1 to GX classification. Even if these equipment have been available for a long time there is still many improvements that could be done.

The present disclosure aims at providing an improved way of monitoring airborne corrosivity that is flexible, cost effective and easy to use.

### SUMMARY

It is an object of the present disclosure to mitigate, alleviate or eliminate one or more of the above-identified deficiencies and disadvantages in the prior art and solve at least the above mentioned problem. According to a first aspect there is provided a sensor connecting bridge configured to be used in connection with a corrosion measuring device for monitoring of airborne corrosivity, the sensor connecting bridge comprising at least one connector assembly configured to enable electrical connection between the measuring device and at least one sensor coupon inserted into the sensor connecting bridge, and a computer readable memory comprising information about the sensor bridge identity.

The at least one connector assembly may include a first connector part configured to connect the sensor connecting bridge to a connector in the measuring device. The at least one connector assembly may include a second connector part the sensor comprises a sensor coupon receiving slot configured to receive a connection end of a sensor coupon. The sensor preferably comprises two connector assemblies arranged in parallel, allowing two sensor coupons to be inserted into the sensor connecting bridge.

The at least one connector assembly may be at least partially arranged within a casing, and a sensor coupon protection plate is preferably arranged on the casing adjacent the sensor coupon receiving slot, said protection plate suitably being configured to shield and protect an active front side of the sensor coupon when inserted into the sensor connecting bridge. One or more ventilation openings adapted to allow air circulation may be provided in the protection plate or in the sensor connecting bridge.

According to a second aspect of the present disclosure, there is provided a sensor coupon adapted to be used in connection with the sensor bridge of the first aspect described above, comprising a non-conductive substrate and a metal track applied on the substrate, wherein the sensor coupon has a connection end at a first edge of the substrate, and the metal track applied to the substrate comprises at least one elongated metal track having an elongated and curved or undulating shape, and includes at least two end portions, comprising connection areas, located at first edge of the substrate. The substrate should preferably have a surface roughness of 5-600 Angstrom. Advantageously, the entire metal film track, including the connection areas, has been applied by thin film technology, where the application technology of the metal film track is preferably the same along its whole length including the connection areas. Most preferably, the metal track is applied by sputtering or vapour deposition or a combination thereof. The metal track may suitably comprise at least one M-shaped part, preferably two or more M-shaped parts. In order to produce a flat and even top surface of the metal track that enables reproducible corrosivity response, the underlying substrate surface need to be equally smooth. The substrate should preferably have a surface roughness of 5-600 Angstrom.

A first part of the metal film track may suitably be covered by a protective layer, which is impermeable to corrosive substances, and at least one second part thereof is then not covered to allow it to be exposed to corrosive substances during use. The active sensor surface suitably comprises a corrodible metal, preferably copper or silver. The substrate may further include a gripping area, which is free from metal track, and which is preferably located at a second end of the substrate opposite to the first connection end of the substrate. The coupon suitably has a width dimension parallel to said first edge and a length dimension perpendicular to said first edge, where W:L is 0.7-1.3, preferably 0.8-1.2, most preferably 0.9-1.1. The substrate may be comprised of glass, alumina or silicon.

According to a third aspect of the present disclosure there is provided a sensor connecting bridge arrangement comprising a sensor connecting bridge according to the first aspect and at least one sensor coupon according second aspect, inserted into the at least one connector.

According to a fourth aspect of the present disclosure there is provided a corrosion measuring device for monitoring of airborne corrosivity, configured to receive and connect to a sensor connecting bridge of the first aspect, the measuring device comprising a least one connector configured to enable electrical connection between the measuring device and the sensor connecting bridge; and an electronic circuit allowing determination of resistance of a metal track of at least one sensor coupon held by the sensor connecting bridge; and an electronic circuit comprising an interface configured to retrieve sensor bridge identity information from the memory in the sensor connecting bridge. The corrosion measuring device may comprise an electronic circuit that allows determination of resistance of the metal track of the sensor coupon by applying current or voltage to the metal track. The corrosion measuring device may further comprise a bridge receiving recess configured to receive and accommodate the sensor bridge and any sensor coupons carried by the sensor connecting bridge, wherein the at least one connector is accessible from the recess. The bridge receiving recess may suitably be arranged at a bottom end on the front side of the device, when positioned in an upright position, and may be open at the front and at the bottom, and may have closed rear wall, side walls, and top wall, wherein the rear wall is suitably configured to extend past any sensor coupon carried by the sensor connecting bridge, and the side walls extend past forward of said sensor coupons, when a sensor bridge carrying sensor coupons is accommodated in the recess. Further, the corrosion measuring device may comprise a microprocessor configured to retrieve corrosivity information based on the determination of the difference in resistance of a not covered metal track versus a covered track of a sensor coupon. The corrosion measuring device may also comprise a display having a graphical user interface. Preferably, the corrosion measuring device comprises a communication unit arranged to transmit corrosivity information to a cloud-based user communication interface.

According to a fifth aspect there is provided a passive sensor connecting bridge holder for offline corrosivity determination, configured to receive and accommodate a sensor connecting bridge of the first aspect and any sensor coupons carried by the sensor connecting bridge, the holder comprising a bridge receiving recess configured to receive and accommodate the sensor bridge and any sensor coupons carried by the sensor connecting bridge. The bridge receiving recess may be arranged at a bottom end on the front side of the holder, when held in an upright position, and is open at the front and at the bottom, and has closed rear wall, side walls, and top wall, and wherein the rear wall is configured to extend past any sensor coupon carried by the sensor connecting bridge, and the side walls extend past forward of said sensor coupons, when a sensor bridge carrying sensor coupons is accommodated in the recess.

According to a sixth aspect there is provided a monitoring system for monitoring of airborne corrosivity in one or more different locations, the system comprising a monitoring device according to the second aspect, one or more sensor connecting bridges according to the first aspect, a set of sensor coupons according to the second aspect, and optionally one or more passive sensor bridge holders according to the fifth aspect configured to accommodate a sensor connecting bridge arrangement during time periods between active measuring occasions.

According to a seventh aspect there is provided a method of monitoring of airborne corrosivity in one or more different locations using the monitoring system of the sixth aspect, comprising the steps of: 1. Inserting fresh sensor coupons according to the second aspect into one or more sensor connecting bridge according to the first aspect, to form one or more sensor connecting bridge arrangement according to the third aspect; 2. Calibrating the sensor connecting bridge arrangement by determining resistance in the fresh sensor coupons by means of a corrosion measuring device according to the fourth aspect; 3. Placing the sensor connecting bridge arrangement in desired location; 4. After a predetermined time period, bringing the corrosion measuring device to the location where the sensor connecting bridge arrangement is; or, bringing the sensor connecting bridge arrangement to the corrosion measuring device; 5. Inserting the sensor connecting bridge into the corrosion measuring device and determining the corrosion of the sensor coupons; 6. Returning the sensor connecting bridge arrangement to its former desired location to continue the measurement at step 3.

Effects and features of the second through seventh aspects are to a large extent analogous to those described above in connection with the first aspect. Embodiments mentioned in relation to the first aspect are largely compatible with the second through seventh aspects. The present disclosure will become apparent from the detailed description given below. The detailed description and specific examples disclose preferred embodiments of the disclosure by way of illustration only. Those skilled in the art understand from guidance in the detailed description that changes and modifications may be made within the scope of the disclosure. Hence, it is to be understood that the herein disclosed disclosure is not limited to the particular component parts of the device described or steps of the methods described since such device and method may vary. It is also to be understood that the terminology used herein is for purpose of describing particular embodiments only, and is not intended to be limiting. It should be noted that, as used in the specification and the appended claim, the articles “a”, “an”, “the”, and “said” are intended to mean that there are one or more of the elements unless the context explicitly dictates otherwise. Furthermore, the words “comprising”, “including”, “containing” and similar wordings does not exclude other elements or steps.

### DETAILED DESCRIPTION

A main improvement area of the present disclosure is to allow both online and offline measurement while at the same time avoiding damages and measurement errors due to sensor connection and disconnections.

Another feature, today a demand for any measurement device, is to provide an abundance of communication methods. This includes to have a transparent and easy to comprehend graphical user interface, GUI, on the unit itself while also giving the possibility to connect to remote computers, surveillance systems, building management systems, BMS, and different cloud services.

Since the standard and all methods are determining the thickness of a corrosion product, it is also unavoidable that the sensor surface is consumed and thus needs to be replaced. It is therefore important that the sensors are reliable, keep close tolerances and also can be made at an affordable cost to the user.

By controlling the immediate space around the sensing surfaces the air flow over the sensor surfaces can be controlled to remove anomalies due to sudden air movements by personnel and equipment as well as direct contact to the sensor surfaces.

The sensor connecting bridge is configured to be used in connection with a corrosion measuring device for monitoring of airborne corrosivity. The sensor connecting bridge comprises at least one connector assembly configured to enable electrical connection between the measuring device and at least one sensor coupon inserted into the sensor connecting bridge, and a computer readable memory comprising information about the sensor bridge identity. The sensor connecting bridge forms a sensor connecting bridge arrangement when at least one, preferably two, sensor coupons have been inserted into the sensor connecting bridge. The sensor connecting bridge can be used for active (real-time) online measurement by keeping the sensor connecting bridge in connection with the measuring device, but it can also be used for passive offline measurement by placing it elsewhere most preferably by using a dedicated passive holder and bringing the sensor connecting bridge to measuring device (or vice versa) and connecting it to the online system at desired points in time, as a “plug-and-play” arrangement. The use of a sensor connecting bridge also allows the combination of multiple sensor connecting bridges with one or a few measuring devices. The sensor connecting bridge also allows facilitated handling of the sensor coupons during measurement because the coupons are held by the bridge and need not be touched by a user or operator. Further, removing the whole bridge and leaving the sensor coupons in place will avoid damages and measurement errors due to sensor connection and disconnection. Thereby, requirements on sturdiness of the sensor coupons can be lowered, which can keep cost down for the sensor coupons. Especially, the connection areas on the sensor coupons need not be as resistant to wearing as in applications where no sensor bridge is used.

The computer readable memory comprising information about the sensor bridge identity allows measured data to be tied to a specific sensor connecting bridge. Thereby, the sensor coupons need not be provided with identity information, further keeping the cost for sensor coupons down.

The sensor coupon intended for use in connection with the sensor bridge comprises a substrate and a metal track applied thereon. Connection areas are included at end portions included in the elongated metal track. The sensor coupon will be described in more detail below. It should be understood that any number of sensors can be used simultaneously with the sensor bridge, and that the sensor bridge will be designed according to the desired number of sensor coupons by providing the bridge with an appropriate number of sensor coupon receiving slots in the bridge. A preferred setup may include two sensor coupons having active sensor tracks made of different materials. In the below, the description may refer to both “sensor coupon” or “sensor coupons”. This should be interpreted as one or more sensor coupons, unless otherwise is explicitly indicated.

The at least one connector assembly preferably includes a first connector part configured to connect the sensor connecting bridge to a connector in the measuring device, and a second connector part the sensor comprises a sensor coupon receiving slot configured to receive a connection end of a sensor coupon.

The first connector part may be in the form of a carrier substrate, for example made of glass fiber containing sheet material, onto which conductive traces of e.g. copper have been applied. The conductive traces are suitably arranged to establish electrical contact with electrical circuitry in a measuring device in connection with which the sensor connecting bridge is to be used. Thus, the first connector part may function as an interface for communication with the measuring device. The computer readably memory comprising sensor bridge identity information may also be held by, or be included in, the first connector part.

The second connector part may be in the form of a connector housing having a sensor coupon receiving slot, where spring loaded contact members may be arranged inside the connector housing so as to be brought into electrical contact with contact areas or connection areas on the sensor coupon when a sensor coupon is inserted into the slot, and to be able retain the sensor coupon in position, also when the sensor connecting bridge is oriented such that the sensor coupon is directed downward without any other supporting member or element. A plurality of pins may be arranged on the outside of the connector housing, typically on a side opposite to the sensor coupon receiving slot. The pins may suitably be arranged to be inserted into through holes arranged in the carrier substrate of the first connector part to establish electrical contact between the spring-loaded contact members of the second connector part and conductive traces on the first connector part.

The sensor connecting bridge may comprise two connector assemblies arranged in parallel, allowing two sensor coupons to be inserted into the sensor connecting bridge. When two or more connector assemblies are included, the carrier substrate can be in one piece, having separate sets of conductive traces for each coupon receiving connector housing.

The at least one connector assembly may suitably be at least partially arranged within a casing, typically made of plastic material. The casing may be a two-part structure comprising a rear part with through openings, through which the first connector part can extend to be accessible outside the casing in a rearward or upward direction, and a front part that can include a handle for convenient handling of the sensor connection bridge. The two parts of the casing can be joined by screw or snap fastener.

The sensor connecting bridge may further comprise a sensor coupon protection plate arranged on the casing adjacent to the sensor coupon receiving slot, typically on the front part of a two-part casing. The protection plate is configured to shield and protect an active front side of the sensor coupon when the coupon is inserted into the sensor connecting bridge and to serve as a front boundary of a sensor coupon space defined by the protection plate and a bridge receiving recess. Accordingly, the protection plate suitably extends in a width and length direction to form a protecting surface at least having the same size as the opening of the bridge receiving recess, and thus being at least as large as the sensor coupons, preferably larger. The protection plate is suitably arranged on the bridge casing so that there is a distance between the protection plate and the surface of the sensor coupon, preferably around 0.2-1.5 cm. The protection plate suitably has one or more through openings allowing air circulation around the sensor coupon in the sensor coupon space, in order to maintain the temperature in the sensor coupon space even and the same as in the environment to be measured. Ventilation openings can also be provided in the casing of the sensor connecting bridge. The sensor coupon space is advantageous since it makes the air flow, temperature and humidity in the immediate surrounding on the sensor surfaces more controlled and not subjected to air movement by passing personnel or air flows from equipment and well as avoiding direct touch. By controlling the immediate space around the sensing surfaces the air flow over the sensor surfaces can be controlled to remove anomalies due to sudden air movements by personnel and equipment as well as direct contact to the sensor surfaces.

The sensor coupons are disposable parts that are consumed and need to be replaced after a certain measuring period. The sensor coupon is then removed from the sensor connecting bridge and is discarded or recycled. The sensor connecting bridge can be used again with a new set of sensor coupons. As the sensor coupons are protected during measurement by the sensor connecting bridge, preferably in combination with a receiving recess in the measuring device (for active measuring) or by a passive sensor bridge holder for passive measuring as described below.

The computer readable memory comprising information about the sensor bridge identity can for example be a read-only memory configured to contain sensor bridge identification data, such as an electrically erasable programmable read-only memory (EEPROM).

The sensor coupon mentioned above, which is adapted to be used in connection with the above sensor connecting bridge comprises an insulating substrate and a thin metal track applied on the substrate. The original resistance of the metal track is preferably 1-10 Ohms, more preferably 4-5 Ohms, in an optimized thickness and area relationship to give the desired sensitivity of corrosion product thickness measurement. If pollution in the air causes the metal to corrode a corrosion product film will form on top of the thin metal track while consequently the cross-sectional area of the track decreases. The metal loss and corrosion product build up will then be possible to register as an increase in electrical resistance. As mentioned above, the sensor coupon is a disposable part of the corrosion measuring equipment and needs to be replaced after some time. Hence, it is important to keep the cost for manufacturing the sensor coupon at an acceptable level. A part of the track or a separate metal track may be covered by a pollution impermeable barrier to serve as a means of temperature compensation for the electrical resistance measurement.

The sensor coupon has at least one connection end at a first end of the substrate, close to the substrate edge, and comprises at least one elongated thin metal track applied to the substrate. The metal track or pattern is applied in an undulating, preferably M-shaped, pattern and includes end portions comprising connection areas, located at the first edge of the substrate and has a first end and a second end, which are both located at the connection end of the substrate. The connection areas may most advantageously be covered by a sputtered gold surface on top of the metal of the metal track, for example copper or silver, to ensure good contact area toward the connector of the sensor connecting bridge, since no oxide layer will form on a gold surface.

The M-shaped pattern preferably has a layout, where each M-part is made up by a track including straight sections forming an “M” by turning 90-degrees six times to form the M-shape. The middle section of the “M” can turn back by 30-70% of the height of the “M”. Preferably, at least two “M”s are present on one sensor coupon, which are connected by a bridge part between the legs of the adjacent “M”s. The end portion comprising the connection areas are suitably located at the end of the M-legs. Further, an additional leg can be provided having connection with one of the M-legs and having a connection area at its end. For example, the connection areas on the M-legs could be used for application of current or voltage, and the connection area on the additional leg could be used to measure resistance.

The substrate is an electrically non-conductive substrate, for example, a ceramic or glass substrate or a board of glass-laminate or glass-fiber composite. The substrate should have a surface roughness of 5-600 Angstrom, preferably 5-100 Angstrom, more preferably 5-50 Angstrom, in order to keep the original surface of the metal track as smooth as possible, to ensure an even build-up of the corrosion product layer during use of the sensor and thereby improve reliability of the corrosion measurement.

Theoretical models for resistance type corrosion sensor measurement are based on the assumption that the corrosion product build-up is completely even, and therefore also that the reduction of available pure metal cross sectional area of the thickness of the metal track is completely even, since the resistance of the cross sectional area is the parameter measured by the measuring device. In addition, the corrosion processes on top of the corroding metal surface is also greatly affected and may even be accelerated by any unevenness present due to initial surface roughness. When the applied sensor metal film track has a very low thickness, this effect has been found to be especially pronounced, especially if the metal track is applied by thin film technology since the applied thin metal film will follow the surface of the substrate. A suitable substrate may for example be obtained by polishing the surface of a glass sheet material to the desired surface roughness of 5-600 Angstrom. Other methods may be used. Unpolished glass may typically have an average surface roughness of approximately 350 nm.

The metal film track is a thin film track, that is preferably applied by thin-film technology, e.g. by PVD metal deposition or sputtering, giving metal layers with a low thickness, which provides a high sensitivity of the resulting sensor. Most preferably, the entire metal track including the connection areas is made by the same application technology. The metal track may preferably have a thickness of 400-1000 nm. At the lower end of the thickness interval, the sensor sensitivity will be higher, but the metal track thickness will still be sufficient to give a reasonably sufficient sensor lifetime, and at the upper end of the interval the sensor can be used in a more corrosive environment. As mentioned above, the thin metal track requires a very smooth substrate surface. The metal track thickness is preferably 400-800 nm, and more preferably 500-600 nm, to ensure high sensitivity and sufficient service life of the sensor. The metal track preferably has a width of 1.7-2.3 mm. By providing the metal track with the M-shaped layout described above and selecting a metal track thickness and width in the specified ranges, the metal track that can be made relatively short, while still having the preferred original resistance of 1-10 Ohms. Thereby, the sensor metal track can be made to fit on a very small piece of sensor coupon substrate, and less metal is required to obtain the sheet, which is important in reducing the cost of the sensor coupon as both the substrate material and especially the sensor metal are expensive materials. In addition, the distance between adjacent edges of the undulating metal track is preferably 0.7-3 mm, thereby making the metal track even more compact and surface effective, while being sufficiently large to avoid the risk of short circuit in case of water droplet buildup, due to condensation, that may bridge between adjacent parts of the metal track.

Accordingly, by adapting the length versus height ratio of a sensor coupon to the length versus height ratio of the entire substrate material the number of sensors can be optimized which improves production speed and lowers scrap and manufacturing cost. This can be achieved if the shape of the film track can be adapted to the most advantageous length versus height ratio of the sensor. Advantageously, the sensor coupon has a width dimension (W) parallel to said first edge (34) and a length dimension (L) perpendicular to said first edge, where W:L is 0.7-1.3, preferably 0.8-1.2, most preferably 0.9-1.1. Substrate material blanks from which the sensor coupon substrate is made often have an approximately square shape, having a typical size of approximately 114×114 mm. Thus, with the selected preferred M-shape of the metal track and the selected dimensions of the sensor coupon, most of the substrate material blank can be made use of, leading to less waste and thus more cost-effective manufacture of sensor coupons. A suitable size may be obtained if the length L of the sensor coupon is approximately 2.5-4.0 cm. Further, the width of the sensor coupon may suitably be approximately 25-40 mm, preferably 30-38 mm to adapt to the size of standard off-the shelf connectors, which are often approximately 31 mm wide.

As mentioned above, contact areas are provided at an end of the sensor coupon and are adapted to be inserted into a measuring device.

Hitherto known sensors of the above type, i.e. in the form of a thin metal track applied on a substrate, are generally made to withstand abrasion when being inserted into the measuring device so as to allow repeated insertion and removal into the contact means of the corrosion measuring device. This can be obtained for example by forming the connection areas of the metal track by thick-film technology, or a combination of a thin-film technology layer onto which a thick-film technology layer, or by applying another wear resistant conductive coating at the connection area. In many previously known cases the entire sensor metal track including the connection areas is made by thick-film technology and etching.

It has been found within the scope of the present invention that connection areas applied by thin film technology only, and having a thickness in the same interval as the sensor metal track above, are sufficiently durable when used with the sensor connecting bridge described herein. The contact areas may be somewhat scratched when inserted into the connector part of the sensor connecting bridge but are still capable of providing sufficient electrical contact to obtain a proper corrosivity measurement. Thus, there is no need for the complicated step of applying a thick-film technology layer on the connection areas that is otherwise generally called for, which means that manufacture of the sensor coupon can be further facilitated and thus less expensive.

Further, the substrate may include a gripping area, which is free from metal track, and which is preferably located at a second end of the substrate opposite to the first connection end of the substrate. The gripping part preferably has a size of 8-15 mm in the length direction of the sensor coupon and a width corresponding to approximately half the width of the sensor coupon. The gipping area is preferably marked by printed text (for example “touch here only) or pattern. The gripping area allows the user to easily hold the sensor coupon for insertion into the sensor connecting bridge without risk of accidentally touching the sensitive sensor track, which could compromise the corrosivity measurement, since contamination on the metal track can affect the resistivity.

Preferably, a first part of the metal film track is covered by a protective layer, which is impermeable to corrosive substances, and thus acts as a reference part, and a second part thereof is not covered to allow it to be exposed to corrosive substances during use and thus acts as a measuring or sensing part. The protective layer or coating may preferably be a polyester film and may preferably be transparent. The measuring part and the reference part of the resulting sensor will suitably have the same shape and size and are typically connected by a bridge part, where the protective layer or coating covers the bridge part in half of its length. The protective layer or coating preferably extends substantially all the way to the substrate edge at the second end of the substrate. When a gripping area is included in the sensor coupon, it is preferably positioned and marked out at the free area between the covered reference part and the substrate edge at the second end of the substrate, and is thus also covered by the protective layer or coating, thereby further reducing the risk of contamination of the sensor metal film track.

During measuring, the sensing part is exposed to air and is intended to corrode. The reference part is covered with a coating serves as temperature compensation. When the sensing part corrodes, the cross-sectional area for conducting current is significantly reduced and the consumption of metal can be directly measured by measuring the increase in resistance. As described on page 2 in “Application of automated corrosion sensors for real-time monitoring in atmospheres polluted with organic acids”, T. Prosek et. al., 18th International Corrosion Congress 2011 Paper 436, by assuming that the electrical conductivity of the pattern is proportional to the remaining thickness of the metal pattern and assuming that corrosion products do not contribute to the conductivity, the corrosion depth of the metallic sensor, Ah, can be calculated according to the equation below:

$$Δ h = {h}_{ref , i} ( \frac{{R}_{P , i}}{{R}_{A , i}} - \frac{{R}_{P}}{{R}_{A}} )$$

where
h_{refi} Initial reference pattern thickness
R_{A} Resistance of the active uncovered part of the metal track
R_{P} Resistance of the passive covered part of the metal track
R_{Ai} Initial resistance of the active uncovered part of the metal track
R_{Pi} Initial resistance of the passive covered part of the metal track.

The metal track of the sensor coupon is preferably comprised of copper metal or silver metal. Preferably, two coupons are used simultaneously, where the active sensor surfaces are different. Most preferably, a sensor coupon with copper sensor pattern is used together with a sensor coupon with silver sensor pattern. The measured parameter will be actual metal loss of the specimen so there is a direct link to the corrosivity despite assumptions made.

The corrosion measuring device for monitoring of airborne corrosivity, in connection with which the sensor connecting bridge is to be used, is an apparatus which is configured to receive and connect to a sensor connecting bridge as described above. The measuring device comprises at least one connector configured to enable electrical connection between the measuring device and the sensor connecting bridge, and an electronic circuit allowing determination of resistance of an active sensor surface of at least one sensor coupon held by the sensor connecting bridge, and an electronic circuit comprising an interface, e.g. an I2C interface, configured to retrieve sensor bridge identity information from the memory in the sensor bridge. The measuring device may be battery operated, which allows it to operate independently and to be easily brought to different locations.

The electronic circuit allows determination of resistance of the active sensor surface of the sensor coupon by applying current or voltage to the active sensor surface, and suitably includes a measuring circuit and a control circuit and other components that are known in the art. Further, the measuring device may comprise a microprocessor configured to retrieve corrosivity information based on the determined active sensor surface resistance, and it may also comprise a communication unit with a transmitter arranged to transmit corrosivity information to a cloud-based user communication interface. The measuring device may also comprise sensors for measuring temperature, relative humidity, and differential/absolute pressure of the environment under test. A memory containing software may suitably be included in the measuring device for saving data and performing calculations and compare the reading to relevant standards, such as ANSI/ISA-71.04-2013.

The at least one connector configured to enable electrical connection between the measuring device and the sensor connecting bridge may be in the form of a connector housing having a contact receiving slot, where spring loaded contact members may be arranged inside the connector housing so as to be brought into electrical contact with the extending portion of the first connector part of the sensor connection bridge when inserted into the slot, and to be able retain the first connector part in position. Thus, the sensor connecting bridge will be securely attached to the measuring device when the extending portion of the first connector part is inserted into the connector of the measuring device.

The measuring device suitably comprises a main printed circuit board including the electronic circuitry needed for the resistance measuring, and preferably also a display with a graphical user interface. The components of the measuring device are preferably held in a casing, which may typically be of plastic material.

The measuring device may further comprise a bridge receiving recess configured to receive and accommodate the sensor bridge, which may have a shape corresponding to that of the sensor connecting bridge. The recess is suitably formed in the casing of the measuring device, and may for example have a substantially cuboid shape, where two sides are open, and three sides are closed, thus providing protection for the sensor coupons during measuring. The measuring device may typically be oriented during use such that the recess for receiving the sensor connecting bridge is located at the bottom of a front part of the device, and having its open sides directed forward and downward. Thereby, the bridge receiving recess can protect the sensor coupons from the rear and from the sides, and the protection plate that can be mounted on the sensor connections bridge can protect the sensor coupons from the front side. Thus, the bridge receiving recess can form a sensor coupon accommodating space together with the protection plate. The bridge receiving recess is configured to protect the rear side and edge sides of the at least one sensor coupon and is together with the protection plate defining the boundaries of a sensor coupon space that allows air connection between an open bottom section and the one or more openings in the upper part of the sensor coupon space adapted to allow air circulation while simultaneously protecting the sensor coupon space and controlling the access of polluted air to the sensor coupon surfaces.

The at least one measuring device connector is suitably located in the recess, in a position corresponding to the extending connector part of the sensor connecting bridge.

As mentioned above, the described sensor connecting bridge and measuring device may be included in a monitoring system for monitoring of airborne corrosivity in one or more different locations. The system may also include a passive sensor connecting bridge holder for offline corrosivity determination, which is configured to receive and accommodate a sensor connecting bridge as described above and any sensor coupons carried by the sensor connecting bridge. The holder suitably comprises a bridge receiving recess configured to receive and accommodate the sensor bridge and any sensor coupons carried by the sensor connecting bridge. Preferably, the bridge receiving recess may be arranged at a bottom end on the front side of the holder, when held in an upright position, and is open at the front and at the bottom, and has closed rear wall, side walls, and top wall, and wherein the rear wall is configured to extend past any sensor coupon carried by the sensor connecting bridge, and the side walls extend past forward of said sensor coupons, when a sensor bridge carrying sensor coupons is accommodated in the recess. The passive sensor bridge holder for offline corrosivity determination having a bridge receiving recess and a protection plate to define the boundaries of a sensor coupon space that allows air connection between an open bottom section and the one or more openings in the upper part of the sensor coupon space adapted to allow air circulation while simultaneously protecting the sensor coupon space and controlling the access of polluted air to the sensor coupon surfaces. Optionally one or more passive sensor connecting bridge holders configured to accommodate a sensor connecting bridge arrangement during time periods between active measuring occasions can be included in the system. The system suitably comprises communication equipment including a transmitter to transmit information to a receiver in a remote location.

The measuring device is preferably arranged to transmit corrosivity information, and preferably also one or more of room temperature, relative humidity, differential pressure/absolute pressure and sensor life information. The corrosivity information transmitted may then preferably be converted to a classification value G1, G2, G3 or GX according to ANSI/ISA-71.04-2013.

For example, information may be transmitted via short-range wireless technology, such as Bluetooth, to a mobile phone, tablet or the like. Information may also be transmitted via wired or wireless communication to remote user networks.

Information may also be transmitted via wired or wireless communication to one or more of building management systems (BMS) controlling HVAC systems, or directly to heating, cooling or ventilation units. Thereby, by including building management systems (BMS) controlling HVAC systems, or heating, cooling or ventilation units in the monitoring system, the environment in a certain location can be adjusted based on corrosivity information obtained by the corrosion measuring device.

The monitoring may be used in a method of monitoring of airborne corrosivity in one or more different locations, comprising the steps of: Inserting fresh sensor coupons into one or more sensor connecting bridge(s) to form one or more sensor connecting bridge arrangement(s); Calibrating the sensor connecting bridge arrangement(s) by determining resistance in the fresh sensor coupons by means of a corrosion measuring device; Placing the sensor connecting bridge arrangement(s) in desired location(s); After a predetermined time period, bringing the corrosion measuring device to the location where the sensor connecting bridge arrangement is; or, bringing the sensor connecting bridge arrangement to the corrosion measuring device; Inserting the sensor connecting bridge into the corrosion measuring device and determining the corrosion of the sensor coupons. Returning the sensor connecting bridge arrangement(s) to its former desired location(s) to continue the measurement.

### BRIEF DESCRIPTIONS OF THE DRAWINGS

The above objects, as well as additional objects, features and advantages of the present disclosure, will be more fully appreciated by reference to the following illustrative and non-limiting detailed description of example embodiments of the present disclosure, when taken in conjunction with the accompanying drawings.

FIG. 1 schematically illustrates a sensor connecting bridge with sensor coupons according to the present invention.

FIG. 2 schematically illustrates a sensor connecting bridge with sensor coupons and a sensor coupon protection plate seen in a perspective view according to the present invention.

FIG. 3 schematically illustrates an exploded view of a sensor connecting bridge comprising a two-part casing and two connector assemblies seen in a perspective view according to the present invention.

FIG. 4 schematically illustrates a corrosion measuring device comprising a display, a bridge receiving recess, two connectors and a disconnected sensor bridge seen in a front view according to the present invention.

FIG. 5 schematically illustrates a corrosion measuring device with connected (attached?) sensor bridge in a perspective view according to the present invention.

FIG. 6 schematically illustrates the front side of a corrosion measuring device comprising a bridge receiving recess with two connectors and two ledges intended to guide and secure a sensor bridge when mounted according to the present invention.

FIG. 7 schematically illustrates a monitoring system according to the present disclosure, comprising a passive holder.

FIG. 8 schematically illustrates a sensor coupon comprising a substrate, an elongated metal track in an undulating shape and several connection areas located at a first edge of the substrate according to the present invention.

FIG. 9 schematically illustrates a sensor coupon comprising a substrate, an elongated metal track in an undulating shape, several connection areas and where a section of the metal track is covered by a layer impermeable to corrosive substances according to the present invention.

FIG. 10 is a block diagram schematically illustrating a method for monitoring of airborne corrosivity in one or more different locations according to the present invention.

FIG. 11 schematically illustrates the different forms of communication between a system for monitoring of airborne corrosivity and display devices, storage or logging devices, cloud services and units for removal of airborne pollution that may be controlled based on the corrosivity information.

### EXAMPLE EMBODIMENTS

The present disclosure will now be described with reference the accompanying drawings, in which preferred example embodiments of the disclosure are shown. The disclosure may, however, be embodied in other forms and should not be construed as limited to the herein disclosed embodiments. The disclosed embodiments are provided to fully convey the scope of the disclosure to the skilled person.

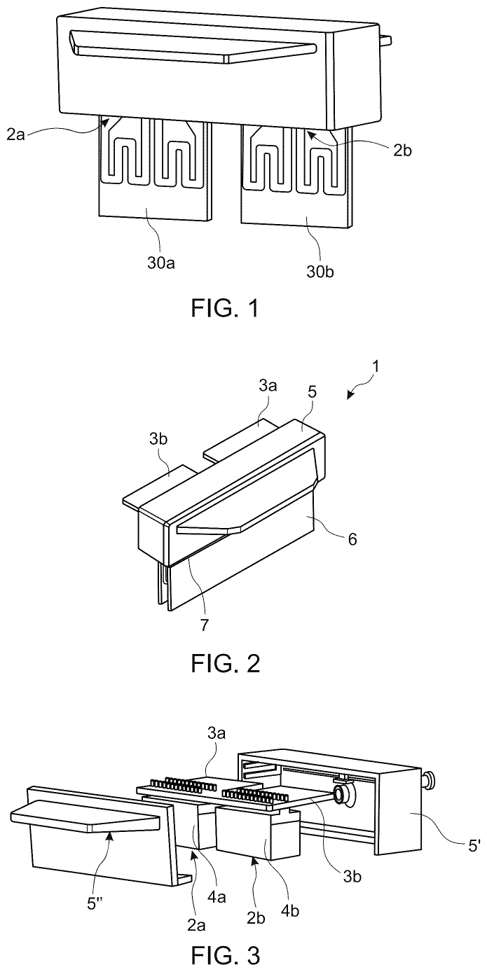

FIGS. 1-3 illustrates a sensor connecting bridge according to the present invention. In FIG. 1, sensor coupons are inserted into the connecting bridge. FIG. 3 is an exploded view showing how the connector assembly can include first and second connector parts.

The first aspect of this disclosure shows a sensor connecting bridge 1 configured to be used in connection with a corrosion measuring device 20 for monitoring of airborne corrosivity, the sensor connecting bridge comprising at least one connector assembly 3a,3b;4a,4b configured to enable electrical connection between the measuring device 20 and at least one sensor coupon 30a,30b inserted into the sensor connecting bridge, and a computer readable memory comprising information about the sensor bridge identity.

In the example shown in FIG. 3, the at least one connector assembly includes a first connector part 3a,4a configured to connect the sensor connecting bridge 1 to a connector 23a, 23b in the measuring device 20, and a second connector part 4a,4b the sensor comprises a sensor coupon receiving slot 2a,2b configured to receive a connection end 33 of a sensor coupon 30a,30b. FIG. 3 is an exploded view showing how the connector assembly can include first and second connector parts. As illustrated, the sensor comprises two connector assemblies 3a,3b;4a,4b arranged in parallel, allowing two sensor coupons 30a,30b to be inserted into the sensor connecting bridge. The at least one connector assembly 3a,3b;4a,4b is at least partially arranged within a casing 5, and a sensor coupon protection plate 6 is arranged on the casing adjacent the sensor coupon receiving slots 2a,2b, said protection plate 6 being configured to shield and protect an active front side of the sensor coupons when inserted into the sensor connecting bridge. FIG. 2 shows how a protection plate 6 is included in the sensor connecting bridge.

As shown in FIG. 2, one or more ventilation openings 7 adapted to allow air circulation are provided in the protection plate 6 or in the sensor connecting bridge.

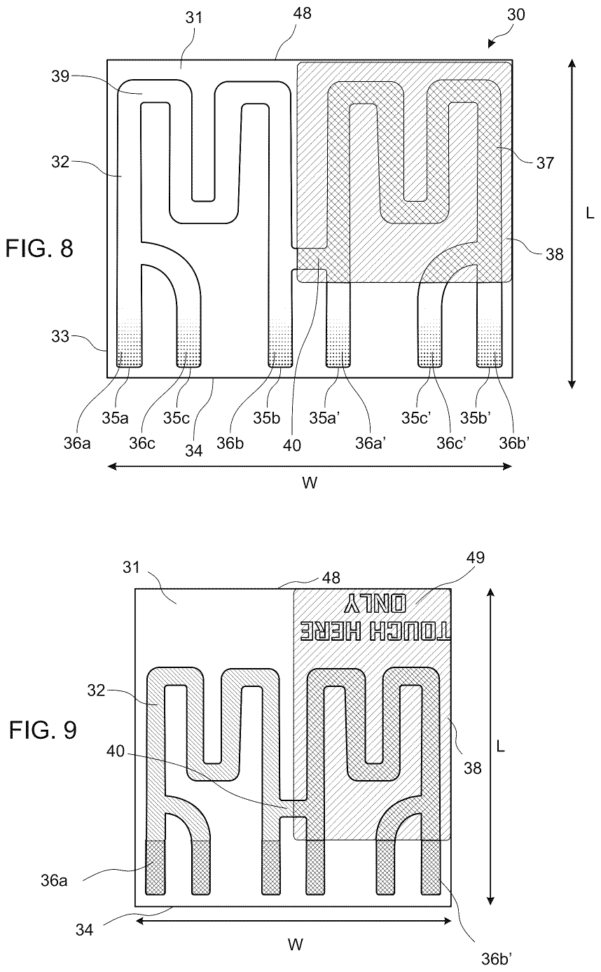

FIGS. 8 and 9 illustrate the second aspect of this disclosure showing a sensor coupon adapted to be used in connection with the sensor bridge 1 of the first aspect, comprising a non-conductive substrate 31 and a metal track 32 applied on the substrate, wherein the sensor coupon has a connection end 33 at a first edge 34 of the substrate, and the metal track applied to the substrate comprises at least one elongated metal track having an elongated and curved or undulating shape, and includes at least two end portions 35a-c,35a′-c′, comprising connection areas 36a-c, 36a′-c′, located at first edge 34 of the substrate. As mentioned above, the entire metal film track has been applied by thin film technology, where the application technology of the metal film track is the same along its whole length including the connection areas and the metal track may be applied by sputtering or vapour deposition or a combination thereof. FIG. 9 illustrates connection areas where a gold layer has been applied to protect the connection areas from corrosion.

FIGS. 8 and 9 show how the metal track comprises at least one M-shaped part, preferably two or more M-shaped parts. The M-shaped pattern preferably has a layout, where each M-part is made up by a track including straight sections forming an “M” by turning 90-degrees six times to form the M-shape. The middle section of the “M” can turn back by 30-70% of the height of the “M”. Preferably, at least two “M”s are present on one sensor coupon, which are connected by a bridge part between the legs adjacent “M”s. The end portion comprising the connection areas are suitably located at the end of the M-legs. Further, an additional leg can be provided having connection with one of the M-legs and having a connection area at its end. For example, the connection areas on the M-legs could be used for application of current or voltage, and the connection area on the additional leg could be used to measure resistance. A first part 37 of the metal film track is covered by a protective layer 38, which is impermeable to corrosive substances, and at least one second part 39 thereof is not covered to allow it to be exposed to corrosive substances during use. The active sensor surface comprises a corrodible metal, preferably copper or silver.

As illustrated in FIG. 9, the substrate can include a gripping area 49, which is free from metal track, and which is preferably located at a second end of the substrate opposite to the first connection end 33 of the substrate. In the illustrated example, the protective layer 38 extends to the second end 48 of the substrate. The sensor coupon preferably has a width dimension W parallel to said first edge 34 and a length dimension L perpendicular to said first edge, where W:L is 0.7-1.3, preferably 0.8-1.2, most preferably 0.9-1.1. The substrate comprises glass, alumina or silicon.

A sensor connecting bridge arrangement comprising a sensor connecting bridge and two sensor coupons 30a, 30b is also illustrated in FIGS. 1-2

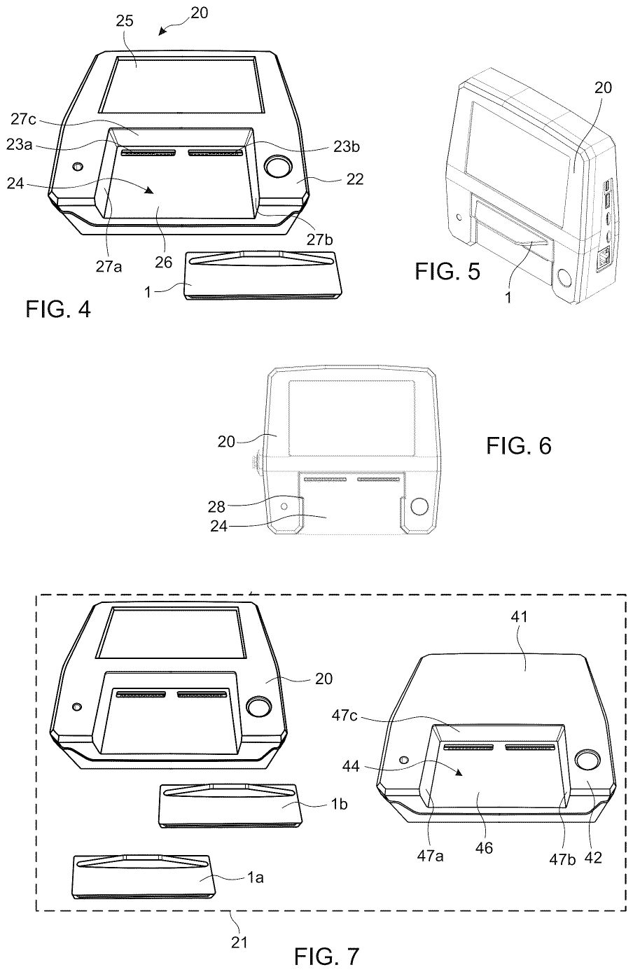

FIGS. 4-6 illustrate a corrosion measuring device for monitoring of airborne corrosivity, configured to receive and connect to a sensor connecting bridge 1 as described above. FIG. 5 show the sensor connecting bridge mounted in the recess 24 of the corrosion measuring device. FIG. 5 shows the corrosion measuring device without the sensor connecting bridge and in this example ledges are provided on each side of the recess, improving the fit of the sensor connection bridge in the recess. In the shown example, the measuring device comprises two connector 23a,23b configured to enable electrical connection between the measuring device 20 and the sensor connecting bridge 1; and an electronic circuit (not shown) allowing determination of resistance of a metal track of at least one sensor coupon 30a,30b held by the sensor connecting bridge 1; and an electronic circuit (not shown) comprising an interface configured to retrieve sensor bridge identity information from the memory in the sensor connecting bridge. The corrosion measuring device comprises an electronic circuit (not shown) that allows determination of resistance of the metal tracks of the sensor coupons by applying current or voltage to the metal tracks.

The corrosion measuring device comprises a bridge receiving recess 24 configured to receive and accommodate the sensor bridge 1 and any sensor coupons carried by the sensor connecting bridge, wherein the at least one connector 23a,23b is accessible from the recess. The bridge receiving recess 24 is arranged at a bottom end on the front side 22 of the device, when positioned in an upright position, and is open at the front and at the bottom, and has closed rear wall 26, side walls 27a,b, and top wall 27c, and wherein the rear wall 26 is configured to extend past any sensor coupon carried by the sensor connecting bridge 1, and the side walls extend past forward of said sensor coupons, when a sensor bridge carrying sensor coupons is accommodated in the recess.

The corrosion comprises a microprocessor configured to retrieve corrosivity information based on the determination of the difference in resistance of a not covered metal track versus a covered track of a sensor coupon. The corrosion comprises a display 25 having a graphical user interface GUI. The corrosion comprises a communication unit arranged to transmit corrosivity information to a cloud-based user communication interface.

The passive sensor connecting bridge holder of the present disclosure, shown to the right in FIG. 7, for offline corrosivity determination, configured to receive and accommodate a sensor connecting bridge 1 of the first aspect and any sensor coupons carried by the sensor connecting bridge, the holder comprising a bridge receiving recess 44 configured to receive and accommodate the sensor bridge 1 and any sensor coupons carried by the sensor connecting bridge. The bridge receiving recess 44 is arranged at a bottom end on the front side 42 of the holder 41, when held in an upright position, and is open at the front and at the bottom, and has closed rear wall 46, side walls 47a,b, and top wall 47c, and wherein the rear wall 46 is configured to extend past any sensor coupon carried by the sensor connecting bridge 1, and the side walls extend past forward of said sensor coupons, when a sensor bridge carrying sensor coupons is accommodated in the recess.

FIG. 7 shows a monitoring system the second aspect for monitoring of airborne corrosivity in one or more different locations, the system comprises a monitoring device 20, two sensor connecting bridges 1a,1b, a set of sensor coupons (not shown), and a passive sensor bridge holder 41 configured to accommodate a sensor connecting bridge arrangement during time periods between active measuring occasions.

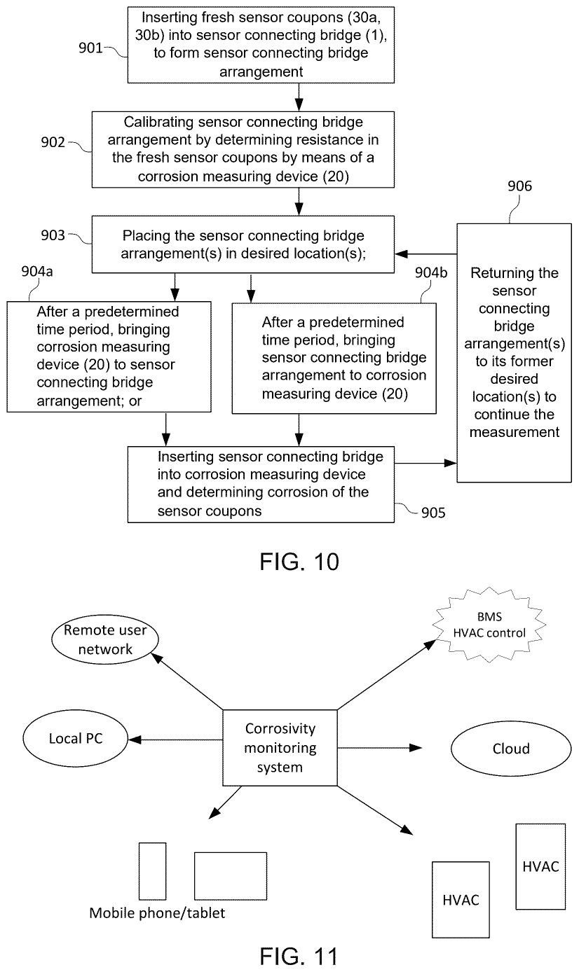

The seventh aspect of this disclosure is a method of monitoring of airborne corrosivity in one or more different locations using the monitoring system, as illustrated in FIG. 10, compressing the steps of. the sixth aspect of the sixth aspect, comprising the steps of: Inserting fresh sensor coupons 30a,30b into one or more sensor connecting bridges 1 to form one or more sensor connecting bridge arrangements 901; Calibrating the sensor connecting bridge arrangements by determining resistance in the fresh sensor coupons by means of a corrosion measuring device 20, 902; Placing the sensor connecting bridge arrangements in desired locations 903; After a predetermined time period, bringing the corrosion measuring device 20 to the location where the sensor connecting bridge arrangement is 904a; or, bringing the sensor connecting bridge arrangement to the corrosion measuring device 20 904b; Inserting the sensor connecting bridge into the corrosion measuring device and determining the corrosion of the sensor coupons 905. Returning the sensor connecting bridge arrangements to its former desired locations to continue the measurement 906.

FIG. 11 schematically illustrates how the monitoring system can transmit data to various locations.

The person skilled in the art realizes that the present disclosure is not limited to the preferred embodiments described above. The person skilled in the art further realizes that modifications and variations are possible within the scope of the appended claims. Additionally, variations to the disclosed embodiments can be understood and effected by the skilled person in practicing the claimed disclosure, from a study of the drawings, the disclosure, and the appended claims.

1. A sensor connecting bridge configured to be used in connection with a corrosion measuring device for monitoring of airborne corrosivity, said sensor connecting bridge comprising
at least one connector assembly configured to enable electrical connection between said measuring device and at least one sensor coupon inserted into the sensor connecting bridge, and
a computer readable memory comprising information about a sensor bridge identity.

2. The sensor connecting bridge of claim 1, wherein the at least one connector assembly includes a first connector part configured to connect the sensor connecting bridge to a connector in the measuring device.

3. The sensor connecting bridge of claim 1, wherein the at least one connector assembly includes a second connector part comprising a sensor coupon receiving slot configured to receive a connection end of a sensor coupon.

4. The sensor connecting bridge of claim 1, comprising two connector assemblies arranged in parallel, allowing two sensor coupons to be inserted into the sensor connecting bridge.

5. The sensor connecting bridge of claim 1, wherein the at least one connector assembly is at least partially arranged within a casing, and a sensor coupon protection plate is arranged on the casing adjacent the sensor coupon receiving slot(s), said protection plate being configured to shield and protect an active front side of the sensor coupon(s) when inserted into the sensor connecting bridge.

6. The sensor connecting bridge of claim 5, wherein one or more ventilation openings adapted to allow air circulation are provided in the protection plate or in the sensor connecting bridge.

7. A sensor coupon adapted to be used in connection with the sensor bridge of claim 1, comprising a non-conductive substrate and a metal track applied on the substrate, wherein the sensor coupon has a connection end at a first edge of the substrate, and the metal track applied to the substrate comprises at least one elongated metal track having an elongated and curved or undulating shape, and includes at least two end portions, comprising connection areas, located at first edge of the substrate, and wherein the substrate has a surface roughness of 5-600 Angstrom and an entire metal film track including the connection areas has been applied by thin film technology.

8. The sensor coupon of claim 7, wherein the metal film track has a thickness of 400-1000 nm.

9. The sensor coupon of claim 8, wherein the metal track is applied by sputtering or vapour deposition or a combination thereof.

10. The sensor coupon of claim 7, wherein the metal track comprises at least one M-shaped part.

11. The sensor coupon of claim 7, wherein a first part of the metal film track is, is covered by a protective layer, which is impermeable to corrosive substances, and at least one second part thereof is not covered to allow it to be exposed to corrosive substances during use.

12. The sensor coupon of claim 7, wherein an active sensor surface comprises a corrodible metal.

13. The sensor coupon of claim 7, wherein the substrate includes a gripping area, which is free from metal track, and which is located at a second end of the substrate opposite to the first connection end of the substrate.

14. The sensor coupon of claim 7, wherein the coupon has a width dimension parallel to said first edge and a length dimension perpendicular to said first edge, where W:L is 0.7-1.3.

15. The sensor coupon of claim 7, wherein the substrate comprises glass, alumina or silicon.

16. A sensor connecting bridge arrangement comprising a sensor connecting bridge according to claim 1 and at least one sensor coupon, inserted into the at least one connector.

17. The sensor connecting bridge arrangement of claim 16, comprising two sensor coupons, where a first sensor coupon has a metal track comprising a first metal, and a second sensor coupon has a metal track comprising a second metal, said first and second metals being different.

18. A corrosion measuring device for monitoring of airborne corrosivity, configured to receive and connect to a sensor connecting bridge of claim 1, said measuring device comprising
a least one connector configured to enable electrical connection between the measuring device and the sensor connecting bridge; and
an electronic circuit allowing determination of resistance of a metal track of at least one sensor coupon held by the sensor connecting bridge; and
an electronic circuit comprising an interface configured to retrieve sensor bridge identity information from the memory in the sensor connecting bridge.

19. The corrosion measuring device of claim 18, comprising an electronic circuit that allows determination of resistance of the metal track(s) of the sensor coupon(s) by applying current or voltage to the metal track(s).

20. The corrosion measuring device of claim 18, comprising a bridge receiving recess configured to receive and accommodate the sensor bridge and any sensor coupons carried by the sensor connecting bridge, wherein the at least one connector is accessible from the recess.

21. The corrosion measuring device of claim 20, wherein the bridge receiving recess is arranged at a bottom end on a front side of the device, when positioned in an upright position, and is open at the front and at the bottom, and has closed rear wall, side walls, and top wall, and wherein the rear wall is configured to extend past any sensor coupon carried by the sensor connecting bridge, and the side walls extend past forward of said sensor coupons, when a sensor bridge carrying sensor coupons is accommodated in the recess.

22. The corrosion measuring device of claim 18, further comprising a microprocessor configured to retrieve corrosivity information based on the determination of a difference in resistance of a not covered metal track versus a covered track of a sensor coupon.

23. The corrosion measuring device of claim 18, further comprising a display having a graphical user interface.

24. The corrosion measuring device of claim 15, further comprising a communication unit arranged to transmit corrosivity information to a cloud-based user communication interface.

25. A passive sensor connecting bridge holder for offline corrosivity determination, configured to receive and accommodate a sensor connecting of claim 1 and any sensor coupons carried by the sensor connecting bridge, said holder comprising a bridge receiving recess configured to receive and accommodate the sensor bridge and any sensor coupons carried by the sensor connecting bridge.

26. The bridge holder of claim 25, wherein the bridge receiving recess is arranged at a bottom end on a front side of the holder, when held in an upright position, and is open at the front and at the bottom, and has closed rear wall, side walls, and top wall, and wherein the rear wall is configured to extend past any sensor coupon carried by the sensor connecting bridge, and the side walls extend past forward of said sensor coupons, when a sensor bridge carrying sensor coupons is accommodated in the recess.

27. A monitoring system for monitoring of airborne corrosivity in one or more different locations, said system comprising a measuring device according to claim 18, one or more sensor connecting bridges, a set of sensor coupons, and optionally one or more passive sensor bridge holders configured to accommodate a sensor connecting bridge arrangement during time periods between active measuring occasions.

28. A method of monitoring of airborne corrosivity in one or more different locations using the monitoring system of claim 27, comprising the steps of:
1) Inserting fresh sensor coupons into one or more sensor connecting bridge(s), to form one or more sensor connecting bridge arrangement(s);
2) Calibrating the sensor connecting bridge arrangement(s) by determining resistance in the fresh sensor coupons by means of a corrosion measuring device;
3) Placing the sensor connecting bridge arrangement(s) in desired location(s);
4) After a predetermined time period, bringing the corrosion measuring device to the location where the sensor connecting bridge arrangement is; or, bringing the sensor connecting bridge arrangement to the corrosion measuring device;
5) Inserting the sensor connecting bridge into the corrosion measuring device and determining the corrosion of the sensor coupons.
6) Returning the sensor connecting bridge arrangement(s) to its former desired location(s) to continue the measurement at step 3.
